(19) United States
(12) Patent Application Publication
(10) Pub. No.: US 2010/0104781 A1
(43) Pub. Date: Apr. 29, 2010

(54) Method for Working a Tube Made from a Metallic Material, and Such a Tube

(75) Inventors: Klaus Schindler, Renchen (DE); Matthias Sauer, Appenweier (DE); Franz Mayer, Oberkirch (DE); Stephan Kasper, Oberkirch (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: PROGRESS-WERK OBERKIRCH AG, Oberkirch (DE)

(21) Appl. No.: 12/605,889

(22) Filed: Oct. 26, 2009

(30) Foreign Application Priority Data
Oct. 27, 2008 (DE) 10 2008 055 688.2

(51) Int. Cl. B32B 1/08; B21D 28/02; B26D 7/08; B26F 1/38

(52) U.S. Cl. 428/34.1; 83/54; 83/684; 72/325

(57) ABSTRACT

In the case of a method for working a tube made from a metallic material, wherein at least one punching is made in a tube wall of the tube at at least one first circumferential location of the tube wall, the tube wall is provided, at at least one second circumferential location, which faces away from the first circumferential location in the circumferential direction, with at least one forming selected from the group that consists of at least one depression of the tube wall, at least one throughhole in the tube wall.

### CROSS REFERENCE TO RELATED APPLICATION

The present application claims priority of German patent application No. 10 2008 055 688.2 filed on Oct. 27, 2008.

### BACKGROUND OF THE INVENTION

The invention relates to a method for working a tube made from a metallic material, wherein at least one punching is made in a tube wall of the tube at at least one first circumferential location of the tube wall.

The invention further relates to a tube made of a metallic material, comprising a tube wall in which at least one punching has been made at at least one first circumferential location of the tube wall.

A method and a tube of the types stated at the outset are known generally through their application or through their use.

Without limitation of the generality, such a tube is used in motor-vehicle construction, as a tension tube of a crossbeam that extends, running approximately horizontally, between the two A-columns beneath the windscreen of a motor vehicle.

One or mere punchings are made in the tube wall of such a tube, such punchings being realized, for example, as a plunging, which are used for self-cutting or self-forming screws, for the purpose of realizing a thread. In the case of such a tube, the punching or punchings are then used for the purpose of fastening further components; for example, in the case of such a tube being used as a tension tube of a crossbeam, further components, for example connecting elements that are to be fastened to the crossbeam, are fastened by screws, by means of the punchings. In the scope of the present invention, the making of at least one punching in the tube wall can be effected, in particular, chiplessly, for example through the afore-mentioned plunging with or without prepunching, but also through piercing or through seaming.

It has been found that, in the case of at least one punching being made in the tube wall of a tube, the tube bends in the region of the made punching. Although, as a rule, the radius of this unwanted bend is relatively small and is only a few millimetres, frequently such a production tolerance is nevertheless too great for the further use of the tube. In the case of the usual methods, therefore, after making of the punching or punchings it is necessary for the tube to be subsequently straightened, this requiring an additional processing step, which increases the production costs and prolongs the production times of such a tube in an unwanted manner. The retro-straightening of the tube is particularly resource-intensive if there have been made in the tube a plurality of punchings that are distributed in the longitudinal direction of the tube. This is because, in this case, a plurality of bends, having differing radii of curvature, can he produced over the length of the tube, which bends, additionally, can also lie in differing planes of curvature. The retro-straightening of the tube is particularly time-consuming in such a case.

### SUMMARY OF THE INVENTION

The invention is therefore based on the object of specifying a method of the type stated at the outset, wherein it is not necessary to straighten the tube after the at least one punching has been made.

The invention is further based on the object of providing a tube produced in this way.

According to an aspect of the invention, a method for working a tube made from a metallic material is provided, the tube having a tube wall defining a longitudinal direction and extending around the longitudinal direction in a circumferential direction, comprising the steps of

making at least punching in the tube wall at at least one first circumferential location of the tube wall, and

providing, at at least one second circumferential location, which faces away from the first circumferential location in the circumferential direction, the tube wall with at least one forming selected from the group consisting of at least one depression of the tube wall, at least one throughhole in the tube wall.

According to another aspect of the invention, a tube made from metallic material is provided, comprising a tube wall defining a longitudinal direction and extending in a circumferential direction about the longitudinal direction,

the tube wall having at least one punching at at least one first circumferential location of the tube wall,

the tube wall being provided, at at least one second circumferential location, which faces away from the first circumferential location in the circumferential direction, with at least one forming selected from the group consisting of at least one depression of the tube wall, at least one throughhole in the tube wall.

The tendency of the tube to bend, in the case of the usual method, upon the at least one punching being made, is at least reduced by the method according to the method, or the bend that has already occurred is reduced or eliminated, in that the tube wall is provided with at least one forming at at least one second circumferential location, which faces away from the first circumferential location as viewed in the circumferential direction. It has been found, in the case of the known method, that the plane of the unwanted bend upon the at least one punching being made lies approximately in the plane in which the punching direction also lies. The at least one forming provided, according to the invention, on the circumferential side that faces away from the location at which the at least one punching is made, produces a counter-force that counteracts an unwanted tendency to bend that occurs upon the at least one punching being made, or, if the punching has already been made, retroactively undoes the bend, at least partially, by a counter-force. According to the invention, the at least one reshaping can be effected in the form of a depression of the tube wall and/or in the form of a throughhole in the tube wall. Depression, in this connection, means that the tube wall is pressed-in, out of its original position, at the second circumferential location, such that, after the depression has been made, the tube, in the region of the second circumferential location, has a lesser inner diameter, or a different cross-section, than before the depression is made. A through-hole in the tube wall is to be understood to mean, within the meaning of the present invention, that the tube wall is provided, at the second circumferential location, with a punching that, in principle, can be effected in the same manner in which the at least one punching is made.

Because of the method according to the invention and the tube according to the invention, it is no longer necessary for the tube to be straightened after the at least one punching has been made, as a result of which the method according to the invention requires less time, despite the additional step of making at least one forming in the tube wall of the tube, and the tube produced according to the invention can be produced cost-effectively.

In a preferred refinement, the at least one forming comprises at least one depression that is made in the tube wall without throughhole in the tube wall.

The advantage of making the at least one forming in the form of a depression that does not punch the tube wall consists in that no weakening of material is caused in the tube wall at the second circumferential location, as can be the case with a throughhole in the tube wall. In other words, in the case of the at least one forming being made in the form of a depression without throughhole in the tube wall, the tube wall does not become “damaged” in the region of the depression.

In a further preferred refinement, the at least one second circumferential location is located at approximately the same height axially in the longitudinal direction of the tube as the first circumferential location.

As already mentioned above, the forming of the tube wall in the region of the second circumferential location results in a stiffening of the tube that counteracts the tendency of the tube to bend upon the at least one punching being made, or that at least reduces a bend that has already occurred as a result of the punching. As a result of the forming being made at approximately the same height axially as the punching itself, this tendency to bend, or the bend, is counteracted in a particularly effective manner, because the tendency to bend, or the bend, is greatest in the axial region around the punching.

In a further preferred refinement, at least two punchings are made in the tube wall at first circumferential locations that are approximately equal in the circumferential direction and that are at a distance apart from one another in the longitudinal direction of the tube, and the forming is made at the at least one second circumferential location, which faces away from the first circumferential locations in the circumferential direction and is arranged, in the longitudinal direction, between the two first circumferential locations.

It is advantageous in this case that the tendency to bend, or the bend, that occurs as a result of two adjacent holes being made, is counteracted by means of only one forming, as a result of which the method according to the invention can be performed with yet lesser expenditure of time.

In preferred refinement, various designs of the depressions are regarded as being advantageous.

Thus, according to a first refinement, the at least one depression can be made in the tube wall as a depression having the shape of a spherical cap.

This can be effected in a very simple manner, for example by pressing a ball into the tube wall at the second circumferential location.

In a further design, the at least one depression is made as an oblong depression in the longitudinal direction of the tube.

It is advantageous in this case that the forming extends over a partial length of the tube wall that is greater than the longitudinal extent of the punching, and consequently can very effectively counteract the tendency to bend. Such an oblong shape depression can also be easily made, for example by pressing a bar into the tube wall or by pressing-in a ball and moving the ball in the longitudinal direction of the tube.

In a further preferred refinement, the at least one depression is made in the tube wall as an oblong depression that is transverse relative to the longitudinal direction of the tube.

Such a design of the depression, likewise, is both easily made in the tube wall and effects a sufficient counter-pressure for the purpose of reducing the tendency of the tube to bend upon the at least one punching being made, or reducing the bend after the punching has been made.

In a further preferred refinement, the at least one depression is made in the tube wall as a flattening of the tube wall.

In this case, the forming is effected by means of a flat pressing tool, for example in the form of a die. Whereas the aforementioned refinements of the at least one depression can constitute a concave depression, as viewed towards the tube wall from outside, a more or less flat shape depression is made in the tube wall by the afore-mentioned refinement.

It is understood that he aforementioned refinements of depressions can be provided in combination with one another on one and the same tube, or only one type of depression can be made in the tube wall, if this appears appropriate for the tube to he produced.

Likewise, it is understood that a plurality of punchings can be made in the tube wall of the tube, which punchings can be arranged in a distributed manner in the longitudinal direction of the tube and in the circumferential direction of the tube, in which case a plurality of formings, preferably in the form of depressions, are then made in a distributed manner on the tube wall. The forming can be offset in relation to the punchings in the longitudinal direction of the tube.

In a further preferred refinement, the at least one punching is made as a plunging in the tube wall.

In this case, the at least one punching serves, for example, as a thread hush, for the purpose of screwing-in a self-cutting or self-forming screw.

In a further preferred refinement, the tube wall is provided with the at least one forming before the at least one punching is made.

It is advantageous in this case that the tendency to bend that occurs upon the punching being made is already counteracted in advance, in that the tube wall undergoes a sufficient stiffening, or is provided with a corresponding counter-force, at the circumferential location opposite the punching that is to be made.

This at least one forming can also, however, be made in the tube wall after the at least one punching is made, in which case a bend that has occurred upon punching is then undone, or at least reduced, by the at least one forming.

Likewise, it s advantageous if the at least one forming is made in the tube wall while the at least one punching is being made, i.e. more or less simultaneously. The advantage of this measure consists in a further reduction of the time expended in the working of the tube, since in this case at least two processing steps are performed at least close to one another in time, as a result of which, for example, repeated clamping of the tube for the respective, corresponding processing step is avoided.

Further advantages and features are disclosed by the following description and the appended drawing.

It is understood that the above-mentioned features and those to be explained in the following can be applied, not only in the respectively specified combination, but also in other combinations or singly, without departure from the scope of the present invention.

### BRIEF DESCRIPTION OF THE DRAWINGS

Exemplary embodiments of the invention are represented in the drawing and explained more fully in the following with reference thereto, wherein:

FIG. 1 shows a portion of a tube, in a first side view;

FIG. 2 shows the tube in FIG. 1, in a further side view rotated by 90° about the longitudinal axis relative to FIG. 1;

FIG. 3 shows a longitudinal section through the tube in FIGS. 1 and 2, in a section along the line III-III in FIG. 1;

FIG. 4 shows a longitudinal section through the tube in FIGS. 1 and 2, in a section along the line IV-IV in FIG. 1;

FIG. 5 shows a cross-section through the tube in FIGS. 1 and 2, in a section along the line V-V in FIG. 2;

FIG. 6 shows a cross-section through the tube in FIGS. 1 and 2, in a section along the line VI-VI in FIG. 2; and

FIG. 7 shows a cross-section through the tube in FIGS. 1 and 2, in a section along the line VII-VII in FIG. 2.

### DETAILED DESCRIPTION OF PREFERRED EXEMPLARY EMBODIMENTS

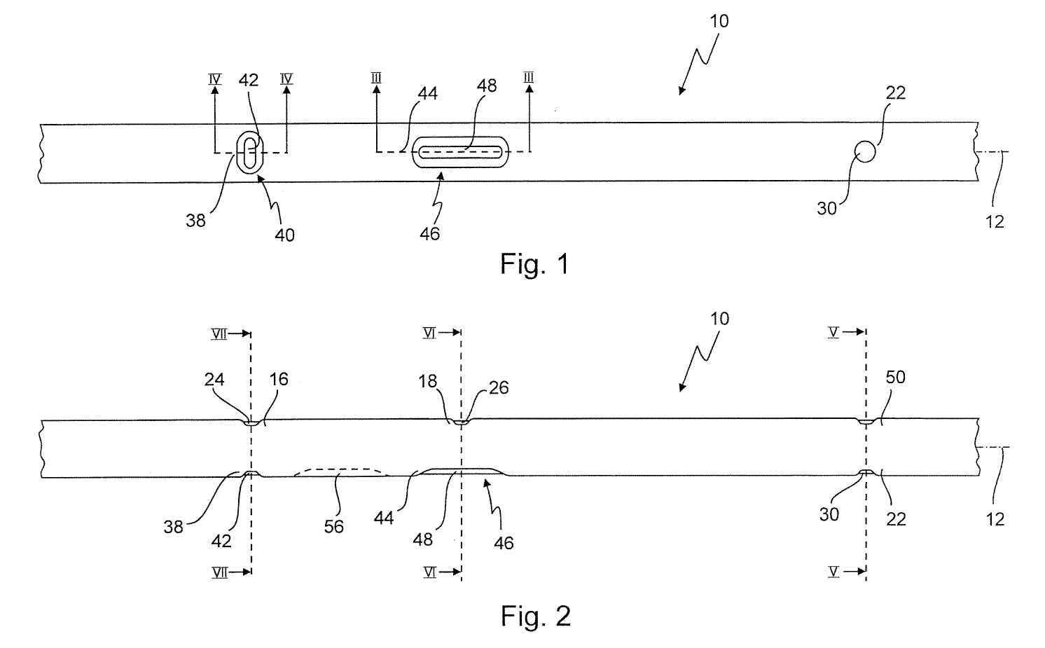

A tube, denoted by the general reference 10, is represented portionally in FIGS. 1 to 7.

The tube 10 is produced from a metallic material, for example from steel, the steel being able to be, in particular, a high-strength steel.

An exemplary application of the tube 10 is its use, in vehicle construction, as a tension tube of a crossbeam that is mounted, running horizontally, between the two A-columns of the body beneath the windscreen.

A longitudinal direction of the tube 10 is represented by a longitudinal axis 12 in FIGS. 1 to 4.

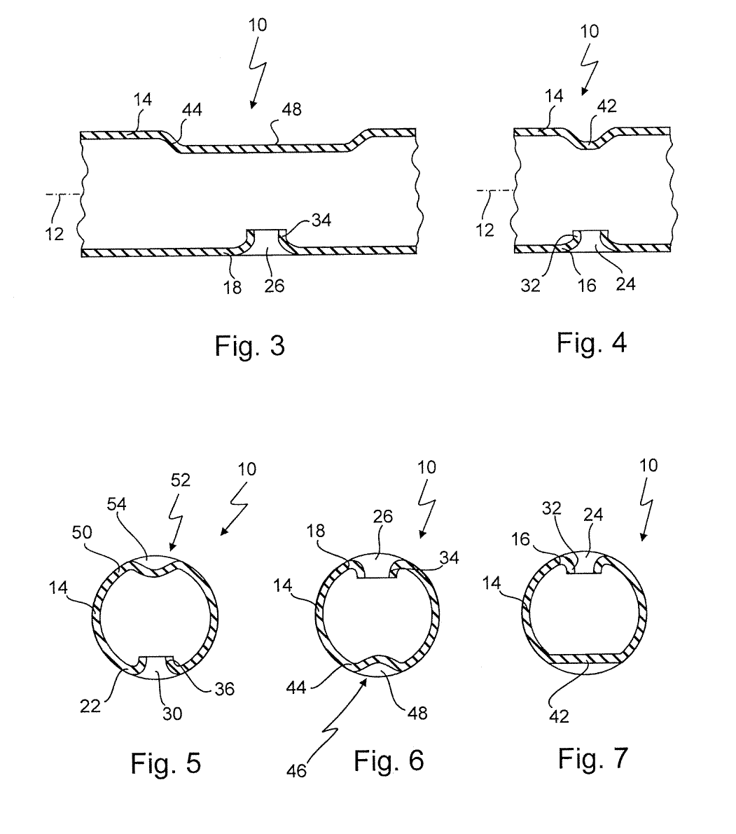

As shown by FIGS. 3 to 7, the tube 10 has a tube wall 14. The tube wall 14 has a wall thickness of, for example, a few (for example, 1 to 5 ) millimetres.

At at least one first circumferential location, being, in the exemplary embodiment shown, at three first circumferential locations 16, 18, 22, a punching has been made, respectively, in the tube wall 14, being a punching 24 at the first circumferential location 16, a punching 26 at the first circumferential location 18 and a punching 30 at the first circumferential location 22.

As represented in FIG. 2, the first circumferential locations 16 and 18, as viewed in the circumferential direction about the longitudinal axis 12, are located at the same angles at circumference about the longitudinal axis 12 and are spaced apart from one another axially, while the first circumferential location 22, as viewed in the circumferential direction about the longitudinal axis 12, is located opposite the first circumferential locations 16 and 18. Within the meaning of the present invention, the first circumferential locations, at which the punchings 24, 26 and 30 have been made, can be distributed in any way in the circumferential direction about the longitudinal axis 12.

In the exemplary embodiment shown, the punchings 24, 26 and 30 are realized as plungings 32, 34 and 36, respectively. The plungings 32, 34, 36 serve, in the case of the further use of the tube 10, as hushes or flanges, for the purpose of screwing-in self-cutting or self-forming screws (not represented).

Before the punchings 24, 26 and 30 have been made in the tube wall 14 of the tube 10, or after the punchings 24, 26, 30 have been made, there is made in the tube wall 14, at at least one second circumferential location, which faces away from the first circumferential location in the circumferential direction, at least one forming selected from the group that includes at least one depression of the tube wall 14 and/or at least one throughhole in the tube wall 14.

The at least one forming can also be made substantially at the same time as the punchings 24, 26, 30.

If the at least one forming is made before the punchings 24, 26, 30 are made in the tube wall 14, the tendency of the tube 10 to bend is reduced, in that the at least one forming, preferably several formings, produce(s) a counter-pressure that counteracts the tendency to bend.

In the exemplary embodiment shown, various types of forming are shown, which are suitable for reducing the tendency of the tube 10 to bend when the punchings 24 to 30 are made in the tube wall 14.

A forming 40 is assigned to the first circumferential location 16 at a second circumferential location 38, which, in relation to the longitudinal axis 12, faces away from the first circumferential location 16, being preferably offset by approximately 180° relative to the first circumferential location 16.

The forming 40 is made in the form of a depression 42, which extends transversely relative to the longitudinal direction of the tube 10 and is realized in the form of an oblong depression that is transverse relative to the longitudinal axis 12. The depression 42 in this case is made as a flattening of the tube wall 14, as represented in FIG. 7. In FIG. 4, the depression 42 is represented in a section in the direction of the longitudinal axis 12. The depression 42 can be made, for example, in the tube wall 14 in that an oblong die, which is oriented with its longitudinal axis transverse relative to the longitudinal axis 12 of the tube 10, is forced into or pressed into the tube wall 14. There is thus produced a head-type depression, which counteracts bending of the tube 10.

Assigned to the punching 26, at a second circumferential location 44, is a forming 46 in the form of a depression 48, which is opposite the punching 26 as viewed in the circumferential direction about the longitudinal axis 12. The forming 46 is made in the tube wall 14 in the form of a depression 48 as shown in FIGS. 3 and 6, the depression 48 being pressed into the tube wall 14 as an oblong depression in the longitudinal direction of the tube 10.

Unlike the depression 42, the depression 48 is straight in the longitudinal direction of the tube 10, being concavely curved in the direction that is transverse relative to the longitudinal direction of the tube 10, as viewed from outside.

The depression 48 is made, for example, by pressing into the tube wall 14 a round bar that is oriented with its longitudinal direction parallel to the longitudinal direction of the tube 10.

Assigned to the punching 30, opposite the latter, at a second circumferential location 50 that faces away from the first circumferential location 22 in the circumferential direction, is a forming 52, which is realized as a depression 54, and which is made in the tube wall 14 as a depression having the shape of a spherical cap.

It is understood that the depressions 42, 48 and 54 described exemplarily above can be used in any number and combinations with one another on one and the same tube. Likewise, it is conceivable for only one type of depression 42, 48, 54 to be made on one and the same tube.

Whereas the second circumferential locations 38, 44 and 50 are arranged, in respect of the first circumferential locations 16, 18, and 22, at approximately the same height axially in the direction of the longitudinal axis 12, the second circumferential locations 38, 44, 50 can, however, also be offset axially relative to the first circumferential locations 16, 18 and 22.

It is thus also possible, in the case of two adjacent punchings, for example the punchings 24 and 26, to effect a forming at a second circumferential location arranged axially between the two second circumferential locations 38 and 44; for example, the depression 48 could be arranged at a circumferential location denoted by the reference 56 in FIG. 2, instead of at the second circumferential location 44. Such a depression would then reduce a tendency of the tube 10 to bend, both upon making of the punching 16 and upon making of the punching 18 in the tube wall 14 of the tube 10, or, if the punchings 16 and 18 have been made previously, reduce back a bend of the tube 10 that has then occurred.

The previously described formings with which the tube wall 14 is provided constitute depressions that are made in the tube wall 14 without piercing of the tube wall 14. The tube wall 14 is not opened by these formings in the form of depressions, and weakenings of material in the region of the forming are thus prevented.

It is also possible, however, in the scope of the invention, for the forming, for the purpose of avoiding a tendency of the tube to bend upon making of the punchings 24, 26 and 30, or for the purpose of reducing a bend after the punchings 24, 26, 30 have been made, to be made in the form of throughholes in the tube wall 14, these throughholes being able, for example, to have exactly the same form as the punchings 24, 26 and 30 themselves.

What is claimed is:

1. A method for working a tube made from a metallic material, said tube having a tube wall defining a longitudinal direction and extending around said longitudinal direction in a circumferential direction, comprising the steps of
making at least punching in said tube wall at at least one first circumferential location of said tube wall, and
providing, at at least one second circumferential location, which faces away from said first circumferential location in said circumferential direction, said tube wall with at least one forming selected from the group consisting of at least one depression of said tube wall, at least one throughhole in said tube wall.

2. The method of claim 1, wherein said at least one forming comprises at least one depression that is made in said tube wall without throughhole in said tube wall.

3. The method of claim 1, wherein said at least one second circumferential location is located at approximately a same height axially in said longitudinal direction of said tube wall as said first circumferential location.

4. The method of claim 1, wherein at least two punchings are made in said tube wall at first circumferential locations that are approximately equal in said circumferential direction and that are at a distance apart from one another in said longitudinal direction of said tube wall, and said forming is made at said at least one second circumferential location, which faces away from said first circumferential locations in said circumferential direction and is arranged, in said longitudinal direction, between said two first circumferential locations.

5. The method of claim 1, wherein said at least one depression is made in said tube wall as a depression having a shape of a spherical cap.

6. The method of claim 1, wherein said at least one depression is made in said tube wall as an oblong depression in said longitudinal direction of said tube.

7. The method of claim 1, wherein said at least one depression is made in said tube wall as an oblong depression that is transverse relative to said longitudinal direction of said tube wall.

8. The method of claim 1, wherein said at least one depression is made in said tube wall as a flattening of said tube wall.

9. The method of claim 1, wherein said tube wall is provided with said at least one forming before said at least one punching is made.

10. The method of claim 1, wherein said tube wall is provided with said at least one forming after said at least one punching is made.

11. The method of claim 1, wherein said tube wall is provided with said at least one forming while said at least one punching is being made.

12. The method of claim 1, wherein said at least one punching is made as a plunging in said tube wall.

13. A tube made of metallic material, comprising
a tube wall defining a longitudinal direction and extending in a circumferential direction about said longitudinal direction,
said tube wall having at least one punching at at least on first circumferential location of said tube wall,
said tube wall being provided, at at least one second circumferential location, which faces away from said first circumferential location in said circumferential direction, with at least one forming selected from the group consisting of at least one depression of said tube wall, at least one throughhole in said tube wall.

14. The tube of claim 13, wherein said at least one forming comprises at least one depression that is made in said tube wall without throughhole in said tube wall.

15. The tube of claim 13, wherein said at least one second circumferential location is located at approximately a same height axially in said longitudinal direction of said tube as said first circumferential location.

16. The tube of claim 13, wherein said tube wall has at least two punchings at first circumferential locations that are approximately equal in said circumferential direction and that are at a distance apart from one another in said longitudinal direction of said tube wall, and said forming is made at said at least one second circumferential location, which faces away from said first circumferential locations in said circumferential direction and is arranged, in said longitudinal direction, between said two first circumferential locations.

17. The tube of claim 13, wherein said at least one depression has a shape of a spherical cap.

18. The tube of claim 13, wherein said at least one depression is an oblong depression in said longitudinal direction of said tube wall.

19. The tube of claim 13, wherein said at least one depression of said tube wall is an oblong depression that is transverse relative to said longitudinal direction of said tube wall.

20. The tube of claim 13, wherein said at least one depression is a flattening of said tube wall.

21. The tube of claim 13, wherein said at least one punching is configured as a plunging in said tube wall.
